(19) United States
(12) Patent Application Publication
(10) Pub. No.: US 2014/0087652 A1
(43) Pub. Date: Mar. 27, 2014

(54) ADAPTIVE SATELLITE POWER TRANSMISSION SYSTEM FOR OVERCOMING RADIO INTERFERENCE IN THE MULTI-BEAM SATELLITE SYSTEM AND COMMUNICATION METHOD

(71) Applicant: ELECTRONICS AND TELECOMMUNICATIONS RESEARCH INSTITUTE, Daejeon (KR)

(72) Inventor: Dae Sub OH, Daejeon (KR)

(73) Assignee: Electronics and Telecommunications Research Institute, Daejeon (KR)

(21) Appl. No.: 13/798,533

(22) Filed: Mar. 13, 2013

(30) Foreign Application Priority Data
Sep. 27, 2012 (KR) 10-2012-0108188

(51) Int. Cl. H04W 52/24; H04B 7/185

(52) U.S. Cl. CPC H04W 52/243; H04B 7/18513
USPC 455/9

(57) ABSTRACT

Disclosed are a satellite power transmission system and a communication method. The satellite power transmission system includes: a reference value determining unit determining reference values of signal to interference ratios for each beam coverage of a multi-beam satellite network system; an interference amount determining unit determining an interference amount for each beam coverage of the multi-beam satellite network system; a signal power determining unit determining signal power corresponding to each beam coverage based on the reference value determined by the reference value determining unit and the interference amount determined by the interference amount determining unit; and a signal power allocating unit allocating the signal power determined by the signal power determining unit to each beam to communicate with each earth station.

### CROSS-REFERENCE TO RELATED APPLICATIONS

This application claims priority to and the benefit of Korean Patent Application No. 10-2012-0108188 filed in the Korean Intellectual Property Office on Sep. 27, 2012, the entire contents of which are incorporated herein by reference.

### TECHNICAL FIELD

The present invention relates an adaptive satellite power transmission system and a communication method, and more particularly, to an adaptive satellite power transmission system and a communication method capable of improving communication performance between a satellite and earth stations by analyzing a radio interference situation of each beam coverage within a coverage of satellite and appropriately distributing transmit power of a satellite to each beam coverage using an appropriate algorithm to maintain a signal to interference ratio (C/I) to a threshold value or more within each beam coverage.

### BACKGROUND ART

In a satellite communication system using a multi beam, the satellite service coverage is configured of several beam coverages similar to terrestrial mobile communication.

In order for the satellite communication system to communicate with earth stations, a signal to interference ratio (C/I) transmitted from a satellite is above a predetermined value. In this case, communications cannot be made due to an interference effect even when the C/I ratio is below a reference value.

A multi-beam satellite communication system until now transmits the same power Cᵢ from a satellite to each service beam Bi. Once the satellite system is launched, a communication system upgrade such as an extension of communication capacity cannot be made until a lifespan of a satellite ends.

Due to characteristics of the satellite communication system, the interference amounts within each beam coverage on the ground are different and thus, when the interference amount of the satellite beam is increased, the C/I ratio of a beam with the increased interference amount is reduced, such that the communication cannot be nearly made.

FIG. 1 is a diagram illustrating the communication environment in which the current multi-beam satellite network allocates and transmits the same signal power C to each beam.

Different interference amounts I1, . . . , I7 occur in each beam coverage B1, . . . , B7 of FIG. 1. In this case, when the same C is allocated to each beam, the C/I value is determined as in a graph illustrated in FIG. 2.

Referring to FIG. 2, it is illustrated that some of the C/I values within each beam coverage exceed a reference value k and others have a smaller value than k due to the different interference within each beam coverages. In this case, in case of beams B2, B5, and B7, C/I>k and therefore, the communication between the satellite and the earth stations can be made, but in case of B1, B3, B4, and B6, C/I<k and therefore, the communication between the satellite and the earth stations cannot be made.

### SUMMARY OF THE INVENTION

The present invention has been made in an effort to provide an adaptive satellite power transmission system and a method capable of improving communication performance between a satellite and earth stations by analyzing a radio interference situation of each beam coverage within a coverage of satellite and appropriately distributing transmit power of a satellite to each beam coverage using an appropriate algorithm to maintain a signal to interface ratio (C/I) to a threshold value or more within each cell.

An exemplary embodiment of the present invention provides an adaptive satellite power transmission system, including: a reference value determining unit determining reference values of signal to interference ratios for each beam coverage of a multi-beam satellite network system; an interference amount determining unit determining an interference amount for each beam coverage of the multi-beam satellite network system; a signal power determining unit determining signal power corresponding to each beam coverage based on the reference value determined by the reference value determining unit and the interference amount determined by the interference amount determining unit; and a signal power allocating unit allocating the signal power determined by the signal power determining unit to each beam to communicate with each earth station.

The adaptive satellite power transmission system may further include: a service information collecting unit collecting information of services corresponding to each beam coverage of the multi-beam satellite network system, wherein the reference value determining unit determines reference values of signal to noise ratios required for each service as reference values of signal to interference ratios for each beam coverage based on service information collected by the service information collecting unit.

The adaptive satellite power transmission system may further include: an interference information collecting unit collecting the interference information in the same frequency band from each earth station communicating with the multi-beam satellite network system, wherein the interference amount determining unit determines the interference amount for each beam coverage based on interference information of each earth station collected by the interference information collecting unit.

The signal power allocating unit may distribute the signal power for each beam coverage according to a set time when a sum of signals in which signal to interference ratios for each beam coverage of the multi-beam satellite system are the reference values or more are larger than maximum signal power provided by a satellite.

The adaptive satellite power transmission system may further include: a earth station inspecting unit inspecting locations of each earth station communicating with the multi-beam satellite network system; and an interference information updating unit updating information of changed frequency information to the interference amount determining unit in real time when the frequency interference within each beam coverage is changed based on the locations of each earth station inspected by the earth station inspecting unit.

Another exemplary embodiment of the present invention provides a communication method performed by an adaptive satellite power transmission system, including: determining reference values of signal to interference ratios for each beam coverage of a multi-beam satellite network system; determining an interference amount for each beam coverage of the multi-beam satellite network system; determining signal power corresponding to each beam coverage based on the reference value determined by the determining of the reference value and the interference amount determined by the determining of the interference amount and allocating the signal power determined in the determining of the signal power to each beam to communicate with each earth station.

The communication method may further include: collecting information of services corresponding to each beam coverage of the multi-beam satellite network system, wherein the determining of the reference value determines reference values of signal to noise ratios required for each service as reference values of signal to interference ratios for each beam coverage based on service information collected in the collecting of the service information.

The communication method may further include: collecting the interference information in the same frequency band from each earth station communicating with the multi-beam satellite network system, wherein the determining of the interference amount determines the interference amount for each beam coverage based on interference information of each earth station collected in the collecting of the interference information.

In the communicating, the signal power for each beam coverage may be distributed according to a set time when a sum of signals in which signal to interference ratios for each beam coverage of the multi-beam satellite system are the reference values or more are larger than maximum signal power provided by a satellite.

The communication method may further include: inspecting locations of each earth station communicating with the multi-beam satellite network system; and updating information of changed frequency information to the interference amount determining unit in real time when the frequency interference within each beam coverage is changed based on the locations of each earth station inspected by the earth station inspecting unit.

According to the exemplary embodiments of the present invention, the power efficiency of the satellite in the multi-beam satellite network system can be maximized by analyzing the radio interference situation of each beam coverage within the coverage of satellite and appropriately distributing the transmit power of the satellite to each beam coverage to maintain the signal to interference ratio (C/I) to the threshold value or more within each cell to maximize the communication performance of the satellite network and minimize the transmit power, thereby improving the overall performance of the satellite system and improving the communication performance between the satellite and the earth stations.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating the communication environment in which the current multi-beam satellite network allocates and transmits the same signal power C to each beam.

FIG. 2 is a graph illustrating a C/I value when the same C is allocated to each beam of FIG. 1.

FIG. 3 is a diagram schematically illustrating a configuration of an adaptive satellite power transmission system according to an exemplary embodiment of the present invention.

FIG. 4 is a diagram illustrating interference amounts within each beam coverage.

FIG. 5 is a diagram illustrating signal power allocation in case of FIG. 4.

FIG. 6 is a diagram illustrating the C/I when k values of each beam coverage are the same.

FIG. 7 is a diagram illustrating an example in which a beam is selected and a time division algorithm is applied when a sum of Cᵢ that is Cᵢ/Iᵢ≧kᵢ is larger than a maximum signal power that can be provided by a satellite.

FIG. 8 is a flow chart illustrating a communication method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, an adaptive satellite power transmission system and a communication method according to an exemplary embodiment of the present invention will be described in detail with reference to the accompanying drawings.

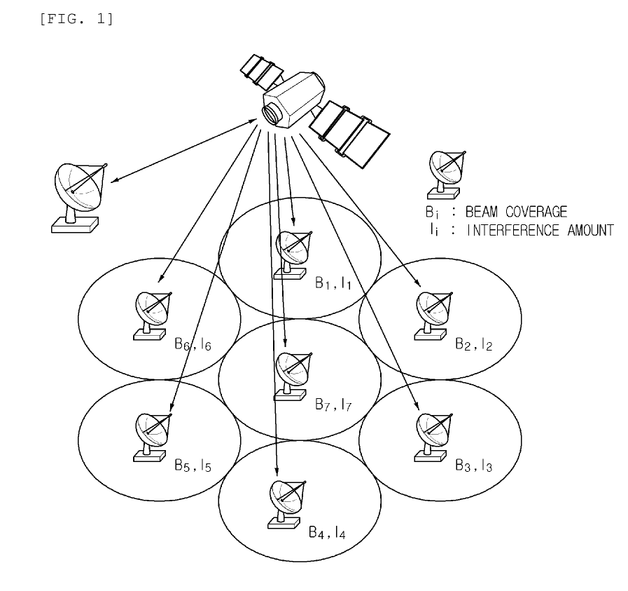

Reviewing a satellite network operation scenario of FIG. 1, a mobile earth station of a satellite service forms a communication link with a satellite and a gateway earth station via the satellite within a coverage in which a satellite service is provided.

The mobile earth station of a satellite network is a user terminal and a user may use voice and data communication through the mobile earth station. The mobile earth station communicates with other mobile earth stations via a satellite and is connected with the gateway earth station to connect with other communication networks or is subjected to a control associated with on operation from the gateway earth station.

The satellite forms a communication link between the mobile earth stations or between the mobile earth station and the gateway earth station. The gateway earth station is an earth station having a switching system and is connected with other communication networks (for example, a PSTN network) or (serves as a satellite and performs a role of a mobile earth station operation control, a billing system operation, and the like.

In the exemplary embodiment of the present invention, in order to determine the communication possibility of the multi-beam satellite system, a descriptive parameter in which the satellite communication system can perform communications by overcoming interference within the same frequency band is defined as a signal to interference ratio C/I and the communication can be made when the C/I value is a reference value k (C/I≧k) or more.

In the beam coverages by the multi beam, the sizes of all of the service coverages and each beam coverage are even larger than a ground in terms of the characteristics of the satellite communication Therefore, the radio environments within each beam coverage are different and the frequency interference amount is also shown as different values in each beam coverage. This means that the C/I ratio values for each beam are different.

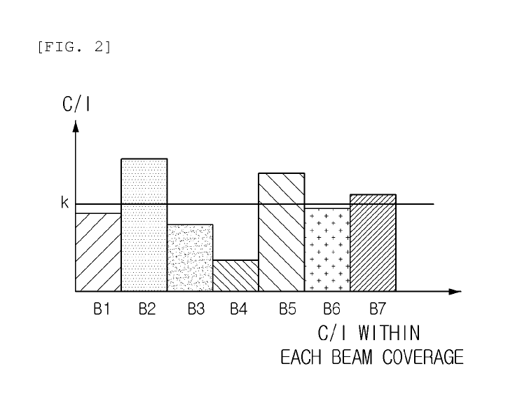

In the existing satellite system, the transmit power of the satellite is transmitted as same value to each satellite beam. Therefore, the Cᵢ values are the same in each beam and the Cᵢ/Iᵢ values are different depending on the different interferences Iᵢ within each beam coverage. Under the conditions, FIG. 2 shows that some C/I values may be even larger than the reference value k in some beam coverage, while others are less than the reference value k in others beam coverage having a large interference amount and thus, communication cannot be made. Therefore, the condition in which the communication cannot be made due to the interference in some beam coverages of the multi-beam satellite network occurs.

The exemplary embodiment of the present invention monitors the Iᵢ values of each beam coverage and maximizes the number of beams in which the Cᵢ/Iᵢ is k or more (C/I≧k) by means of allocating the Cᵢ values dynamically instead of static allocation of equal Cᵢ.

By the way, in the multi-beam satellite network system, each beam coverage may provide different services. For example, when beam coverage 1 provides fixed satellite communication, beam coverage 2 provides multi cast, and beam coverage 3 provides a satellite broadcasting service, the kᵢ values of C/I≧kᵢ required in each beam coverage may be different even though all the communications are based on data communication. Therefore, in order to efficiently use a power resource of the satellite communication system, the optimal C value may be allocated to the k values of each beam coverage.

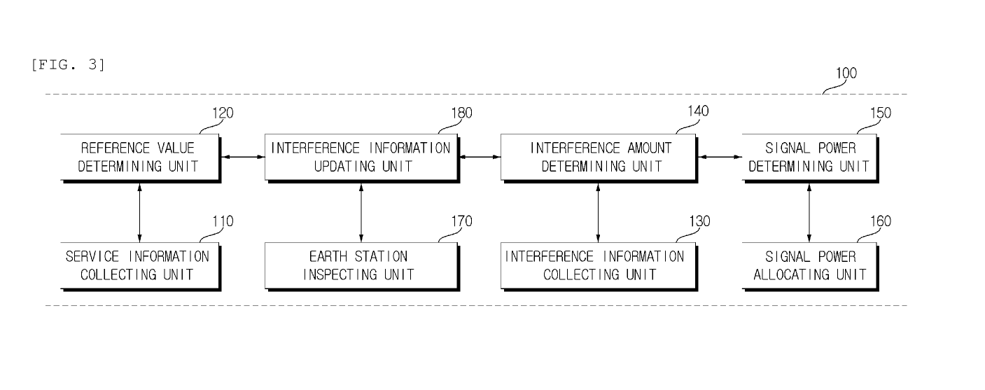

FIG. 3 is a diagram schematically illustrating a configuration of an adaptive satellite power transmission system according to an exemplary embodiment of the present invention.

Referring to FIG. 3, the adaptive satellite power transmission system according to the exemplary embodiment of the present invention may include a service information collecting unit 110, a reference value determining unit 120, an interference information collecting unit 130, an interference amount determining unit 140, a signal power determining unit 150, a signal power allocating unit 160, a earth station inspection unit 170, and an interference information updating unit 180.

The service information collecting unit 110 collects service information corresponding to each beam coverage of the multi-beam satellite network system.

The reference value determining unit 120 determines the reference values of signal to interference ratios for each beam coverage of the multi-beam satellite network system. That is, when the services of each beam coverage are different, the reference values kᵢ of each beam are different and the reference value determining unit 110 determines the reference values kᵢ required for services. In this case, the reference value determining unit 120 determines the reference values of signal to noise ratios required for each service as the corresponding reference values of signal to interference ratios for each beam coverage based on the service information collected by the service information collecting unit 110.

The earth station inspection unit 170 inspects each earth station. The earth station inspecting unit 170 may inspect the locations of each earth station communicating with the multi-beam satellite network system.

After each earth station is inspected, the interference information updating unit 180 updates the interference information of each earth station. When the frequency interference within each beam coverage of the satellite is changed based on the locations of each earth station inspected by the earth station inspecting unit 170, the interference information updating unit 180 may update the information of the changed frequency interference to the interference amount determining unit 140 in real time.

The interference information collecting unit 130 collects the interference information in the same frequency band from each earth station communicating with the multi-beam satellite network system.

The interference amount determining unit 140 determines the interference amount for each beam coverage of the multi-beam satellite network system. In this case, the interference amount determining unit 140 may determine the interference amounts for each beam coverage based on the interference information of each earth station collected by the interference information collecting unit 130.

The signal power determining unit 150 determines the signal power corresponding to each beam coverage based on the reference value determined by the reference value determining unit 120 and the interference amount determined by the interference amount determining unit 140.

The signal power allocating unit 160 allocates the signal power determined by the signal power determining unit 150 to each beam to communicate with each earth station. In this case, the signal power allocating unit 160 may distribute the signal power for each beam coverage according to the set time when a sum of the signals in which the signal to noise ratios for each beam coverage of the multi-beam satellite network system are the reference value or more is larger than the maximum signal power that can be provided by a satellite.

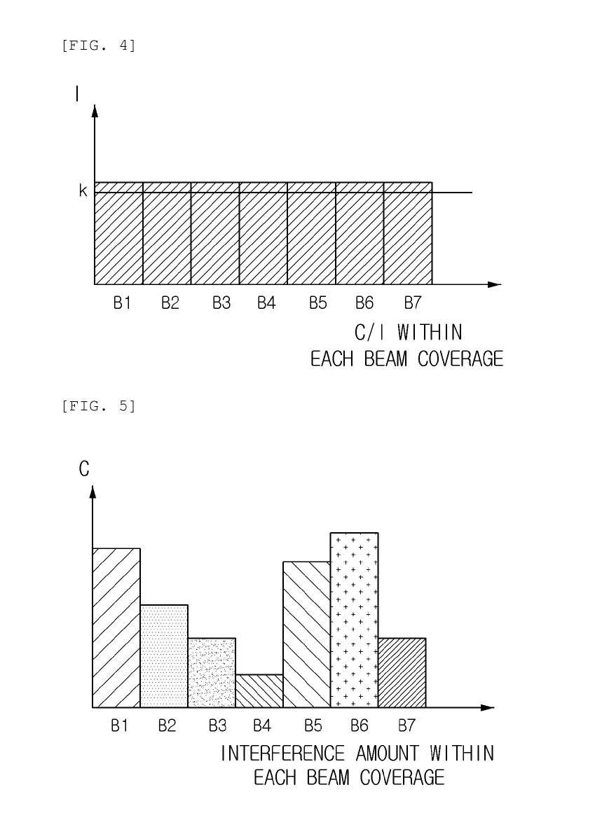

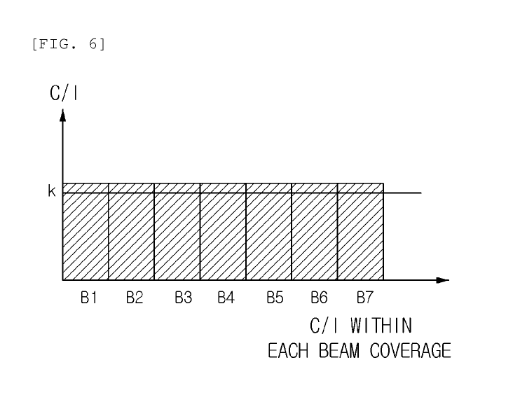

FIG. 4 is a diagram illustrating interference amounts within each beam coverage, and FIG. 5 is a diagram illustrating signal power allocation with regard to the interferences in case of FIG. 4.

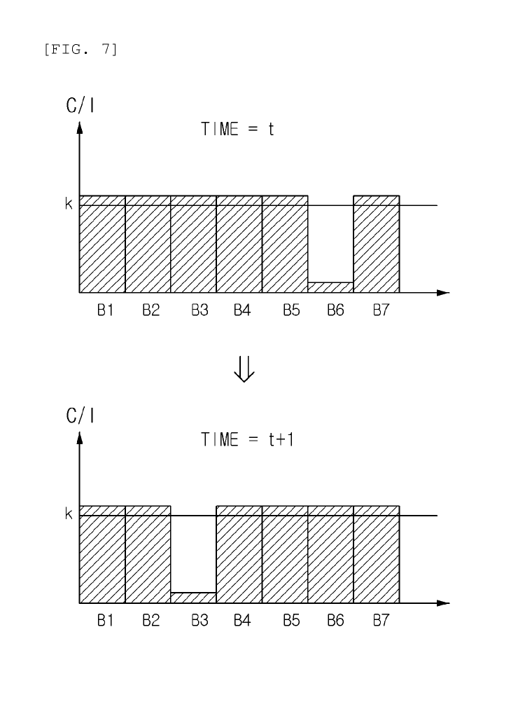

When the interference amounts distributed randomly within each beam coverage as illustrated in FIG. 4, the signal power allocating unit 160 may allocate the signal power in consideration of the interference amounts of each beam coverage as illustrated in FIG. 5. In this case, the present invention maximizes the number of beams in which the C/I is a reference value K or more (C/I≧k) as illustrated in FIG. 6.

FIG. 6 is a diagram illustrating the C/I when k values of each beam coverage are the same. That is, the case in which the k values of each beam coverage are the same as kᵢ=k in C/I≧kᵢ required in each beam is illustrated.

In this case, there is an ideal condition in which a total sum of Cᵢ that is Cᵢ/kᵢ within all the beam coverages (7 in FIGS. 4 to 6) is not larger than the maximum signal power Cₜₒₜₐₗ that may be provided by the satellite.

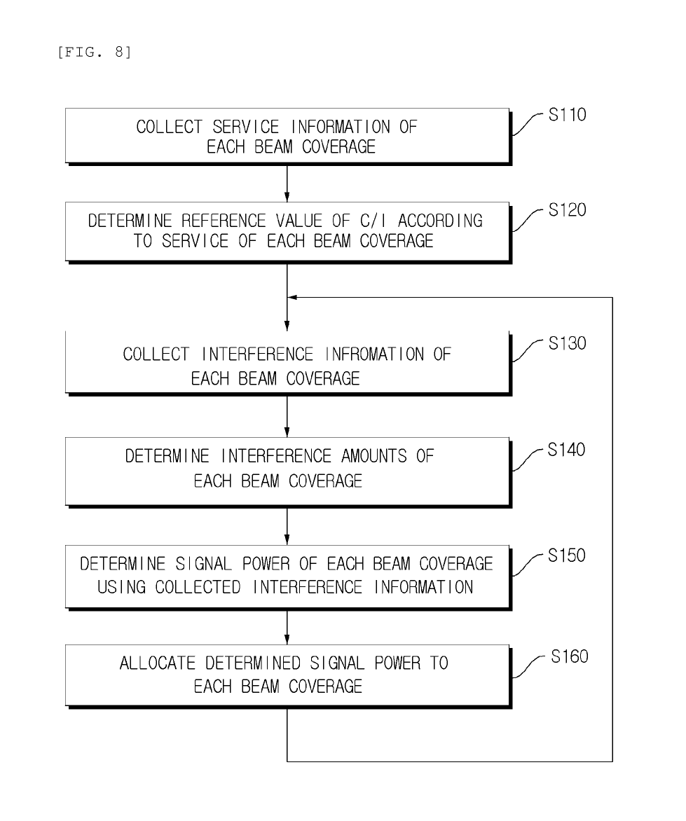

As illustrated in FIG. 7, when the sum of Cᵢ that is Cᵢ/Iᵢ≧kᵢ is larger than the maximum signal power that may be provided by the satellite, ΣCᵢ>Cₜₒₜₐₗ, such that the communication cannot be made in all the beam coverages. In this case, the signal power needs to be appropriately distributed and transmitted according to the beam and time by using a selection algorithm and a time division algorithm.

However, when the satellite system is generally designed, the maximum power transmission capacity of the satellite is determined by estimating the entire coverage of the satellite system and the entire system transmission capacity. Therefore, the case in which the maximum transmission signal power is equal to or larger than the sum of Cᵢ of each beam coverage may be general, but the abnormal condition in which the Cᵢ value that is temporarily very large is required due to the occurrence of the condition in which the interference amount within the specific beam coverage is very large can be overcome by allocating the signal power using the foregoing selection algorithm and time division algorithm.

The earth station inspecting unit 170 may inspect the locations of each earth station communicating with the multi-beam satellite network system. In this case, when the frequency interference within each beam coverage of the satellite is changed based on the locations of each earth station inspected by the earth station inspecting unit 170, the interference information updating unit 180 may update the information of the changed frequency interference to the interference amount determining unit 140 in real time.

FIG. 8 is a flow chart illustrating a communication method according to an exemplary embodiment of the present invention.

Referring to FIGS. 3 and 8, the service information collecting unit 110 collects the information of services corresponding to each beam coverage of the multi-beam satellite network system (S110).

The reference value determining unit 120 determines the reference values of signal to interference ratios for each beam coverage of the multi-beam satellite network system (S120). In this case, the reference value determining unit 120 determines the reference values of signal to noise ratios required for each service as the corresponding reference values of signal to interference ratios for each beam coverage based on the service information collected by the service information collecting unit 110.

The interference information collecting unit 130 collects the interference information in the same frequency band from each earth station communicating with the multi-beam satellite network system (S130).

The interference amount determining unit 140 determines the interference amount for each beam coverage of the multi-beam satellite network system (S140). In this case, the interference amount determining unit 140 may determine the interference amounts for each beam coverage based on the interference information of each earth station collected by the interference information collecting unit 130.

The signal power determining unit 150 determines the signal power corresponding to each beam coverage based on the reference value determined by the reference value determining unit 120 and the interference amount determined by the interference amount determining unit 140 (S150).

The signal power allocating unit 160 allocates the signal power determined by the signal power determining unit 150 to each beam to communicate with each earth station (S160). In this case, the signal power allocating unit 160 may distribute the signal power for each beam coverage according the set time when a sum of the signals in which the signal to noise ratios for each beam coverage of the multi-beam satellite network system are the reference value or more is larger than the maximum signal power that can be provided by a satellite. And then, S130 to S160 is repeated.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An adaptive satellite power transmission system, comprising:
a reference value determining unit determining reference values of signal to interference ratios for each beam coverage of a multi-beam satellite network system;
an interference amount determining unit determining an interference amount for each beam coverage of the multi-beam satellite network system;
a signal power determining unit determining signal power corresponding to each beam coverage based on the reference value determined by the reference value determining unit and the interference amount determined by the interference amount determining unit; and
a signal power allocating unit allocating the signal power determined by the signal power determining unit to each beam to communicate with each earth station.

2. The adaptive satellite power transmission system of claim 1, further comprising:
a service information collecting unit collecting information of services corresponding to each beam coverage of the multi-beam satellite network system,
wherein the reference value determining unit determines reference values of signal to noise ratios required for each service as reference values of signal to interference ratios for each beam coverage based on service information collected by the service information collecting unit.

3. The adaptive satellite power transmission system of claim 1, further comprising:
an interference information collecting unit collecting the interference information in the same frequency band from each earth station communicating with the multi-beam satellite network system,
wherein the interference amount determining unit determines the interference amount for each beam coverage based on interference information of each earth station collected by the interference information collecting unit.

4. The adaptive satellite power transmission system of claim 1, wherein the signal power allocating unit distributes the signal power for each beam coverage according to a set time when a sum of signals in which signal to interference ratios for each beam coverage of the multi-beam satellite system are the reference values or more are larger than maximum signal power provided by a satellite.

5. The adaptive satellite power transmission system of claim 1, further comprising:
a earth station inspecting unit inspecting locations of each earth station communicating with the multi-beam satellite network system; and
an interference information updating unit updating information of changed frequency information to the interference amount determining unit in real time when the frequency interference within each beam coverage is changed based on the locations of each earth station inspected by the earth station inspecting unit.

6. A communication method performed by an adaptive satellite power transmission system, comprising:
determining reference values of signal to interference ratios for each beam coverage of a multi-beam satellite network system;
determining an interference amount for each beam coverage of the multi-beam satellite network system;
determining signal power corresponding to each beam coverage based on the reference value determined by the determining of the reference value and the interference amount determined by the determining of the interference amount; and
allocating the signal power determined in the determining of the signal power to each beam to communicate with each earth station.

7. The communication method of claim 6, further comprising:
collecting information of services corresponding to each beam coverage of the multi-beam satellite network system,
wherein the determining of the reference value determines reference values of signal to noise ratios required for each service as reference values of signal to interference ratios for each beam coverage based on service information collected in the collecting of the service information.

8. The communication method of claim 6, further comprising:
collecting the interference information in the same frequency band from each earth station communicating with the multi-beam satellite network system,
wherein the determining of the interference amount determines the interference amount for each beam coverage based on interference information of each earth station collected in the collecting of the interference information.

9. The communication method of claim 6, wherein in the communicating, the signal power for each beam coverage is distributed according to a set time when a sum of signals in which signal to interference ratios for each beam coverage of the multi-beam satellite system are the reference values or more are larger than maximum signal power provided by a satellite.

10. The communication method of claim 6, further comprising:
inspecting locations of each earth station communicating with the multi-beam satellite network system; and
updating information of changed frequency information to the interference amount determining unit in real time when the frequency interference within each beam coverage is changed based on the locations of each earth station inspected by the earth station inspecting unit.
